(19) United States
(12) Patent Application Publication
(10) Pub. No.: US 2013/0136454 A1
(43) Pub. Date: May 30, 2013

(54) LIGHT EMITTING DIODE LIGHT SOURCE

(71) Applicant: Hung-Ta Yu, New Taipei City (TW)

(72) Inventor: Hung-Ta Yu, New Taipei City (TW)

(21) Appl. No.: 13/444,561

(22) Filed: Apr. 11, 2012

(30) Foreign Application Priority Data
Nov. 30, 2011 (TW) 100144011

(51) Int. Cl. F21V 21/00; H04B 10/00

(52) U.S. Cl. 398/106; 362/235

(57) ABSTRACT

An LED light source comprises a light source plate, a supporting frame, a transceiver module, a driving element and a secondary optical element. The light source plate comprises a first circuit board and a plurality of light emitting elements. The supporting frame comprises a pillar portion. The transceiver module comprises an antenna unit and a radio frequency unit. The antenna unit is disposed on the pillar portion for receiving a radio frequency signal and transmitting it to the radio frequency unit. The radio frequency unit outputs a driving signal to the driving element according to the radio frequency signal. The driving element drives each of the light emitting elements according to the driving signal. The light beams supplied by the light emitting elements are emitted from the secondary optical element. Therefore, users can remotely control the light source through wireless manners.

### CROSS-REFERENCE TO RELATED APPLICATIONS

This non-provisional application claims priority under 35 U.S.C. §119(a) on Patent Application No(s). 100144011 filed in Taiwan, R.O.C. on Nov. 30, 2011, the entire contents of which are hereby incorporated by reference.

### BACKGROUND

1. Technical Field

The invention relates to a light emitting diode (LED) light source, and more particularly to a LED light source which can be remotely controlled through wireless manners.

2. Related Art

Generally, switches of lamp sockets are mostly installed on walls. Users have to manually switch the switches to turn on or turn off lights. The switches of lamp sockets are often installed at different locations, and therefore users have to go around the room to switch the switches in order to turn on or off lighting apparatuses. Obviously, it is very inconvenient for users to control the lighting apparatuses.

Furthermore, as people are demanding higher life quality, lighting apparatuses are no longer limited to be used for the pure purpose of illumination. Rather, it is desired that lighting apparatuses can also be set in different lighting modes for different situations such as drama or dance, so that the audience can enjoy different visual effects. In this circumstance, if switches of the lighting apparatuses are still installed on walls, in order to meet different lighting modes, operators not only need to pay attention to the time point for operating the switches as well as the intensity of illumination, but also have to walk around to control the switches positioned at different locations.

With technology development and awareness of environmental protection, incandescent lamp is being replaced because of its drawbacks, such as low efficiency, high power consumption and short service life. In recent years, light emitting diode (LED) has become one of the main light sources in daily life applications because of its advantages of long service life, lower power consumption, fast reaction rate, high impact-resistance, high resistance to weather, compact size, high lighting efficiency and light weight. However, the light emitted by light emitting diode is limited in a certain range (i.e., LED has high directionality) due to its packaging and other structural factors. Therefore, LEDs cannot completely replace incandescent lamps. In view of this, manufacturers are researching and developing a LED light source having convenient switching functions for different lighting situations.

### SUMMARY

The invention discloses a LED light source so as to resolve existing problems in prior art, which further provides users convenient manners of switching lighting modes.

According to an embodiment of a LED light source disclosed in the invention, the LED light source comprises a base, a light source plate, a supporting frame, a transceiver module, a driving element and a secondary optical element. The secondary optical element connected to the base covers the light source plate, the supporting frame and an antenna unit. The light source plate comprises a first circuit board and a plurality of light emitting elements. The first circuit board is disposed on the base and each of the light emitting elements is disposed on the first circuit board. The supporting frame comprises a flat plate portion and a pillar portion connected to the flat plate portion. The flat plate portion is disposed on the first circuit board and has at least one opening for exposing each of the light emitting elements. The transceiver module comprises the antenna unit and a radio frequency unit. The antenna unit is disposed on the pillar portion, the radio frequency unit is coupled to the antenna unit, and the driving element is coupled to the radio frequency unit and the first circuit board. The antenna unit receives and transmits a radio frequency signal to the radio frequency unit. The radio frequency unit outputs a driving signal to the driving element according to the radio frequency signal, and the driving element drives each of the light emitting elements according to the driving signal.

In one embodiment, the pillar portion has an accommodation space in which the antenna unit is disposed.

In one embodiment, the radio frequency signal is compliant with standards of ZigBee communication protocol.

In one embodiment, the LED light source further comprises a second circuit board, and the radio frequency unit and the driving element are disposed on the second circuit board.

According to another embodiment of a LED light source disclosed in the invention, the LED light source comprises a base, a light source plate, a supporting frame, a secondary optical element, a heat dissipation element, a transceiver module and a driving element. The light source plate comprises a first circuit board and a plurality of light emitting elements. The first circuit board is disposed on the base and each of the light emitting elements is disposed on the first circuit board. The supporting frame comprises a flat plate portion and a pillar portion connected to the flat plate portion. The flat plate portion is disposed on the first circuit board and has at least one opening for exposing each of the light emitting elements. The secondary optical element connected to the base covers the light source plate and the supporting frame. The heat dissipation element is disposed on the secondary optical element. The transceiver module comprises a receiving unit and a micro-processing unit. The receiving unit is disposed on the heat dissipation element, the micro-processing unit is coupled to the receiving unit, and the driving element is coupled to the micro-processing unit and the first circuit board. The receiving unit receives and transmits an infrared signal to the micro-processing unit. The micro-processing unit receives and decodes the infrared signal and outputs a driving signal to the driving element. The driving element drives each of the light emitting elements according to the driving signal.

In one embodiment, the base comprises a dissipation block and a light source plug. The driving element comprises a detecting unit. The detecting unit is used to detect the position of the heat dissipation block relative to the light source plug and thus output a group signal to the driving element. The driving element uses the group signal to judge whether to driving each light emitting element based on the driving signal.

In one embodiment, the detecting unit is a multistage switch.

In one embodiment, the detecting unit is a position sensor.

Based on the above, according to embodiments of LED light source, users can turn on and turn off the LED light source and adjust the illumination intensity and the light field distribution of the LED light source by the configuration of the transceiver module based on a remote wireless control. The transceiver module can receive infrared signals and radio frequency signals.

In addition, when users in an environment where there are a plurality of LED light sources and the transceiver module receives radio frequency signals, because the radio frequency signal includes group data, each driving element can judge whether to drive the LED light source according to the driving signal by comparing the group data included in the radio frequency signal with the group data set in each driving element.

When users in an environment where there are a plurality of LED light sources and the transceiver module receives infrared signals, the position of the heat dissipation block relative to the light source plug makes the detecting unit output the group signal for determining the group defined by each LED light source. Therefore, each driving element can judge whether to drive the LED light source according to the driving signal by comparing the group data included in the group signal with the group data that users want to drive in the driving signal. The detecting unit may be a multistage switch or a position sensor.

The summary above and the following detailed embodiments are intended to illustrate the spirit and principle of the invention. The present invention will become more fully understood by reference to the following detailed description thereof when read in conjunction with the attached drawings.

### BRIEF DESCRIPTION OF THE DRAWINGS

The invention will become more fully understood from the detailed description given herein below for illustration only, and thus are not limitative of the invention, and wherein:

FIG. 1 is an exploded perspective view of a LED light source according to an embodiment of the disclosure;

FIG. 2 is a cross-section structural view of the embodiment of the LED light source in FIG. 1;

FIG. 3A is a perspective view showing a position of an antenna unit according to an embodiment of the disclosure;

FIG. 3B is a perspective view of showing a position of the antenna unit according to another embodiment of the disclosure;

FIG. 4 is a circuit block diagram according to the structure in FIG. 2;

FIG. 5 is a chart showing transmission efficiencies corresponding to different transmission frequencies according to the antenna unit in FIG. 2;

FIG. 6 is an exploded perspective view a LED light source according to another embodiment of the disclosure;

FIG. 7 is a cross-section structural view of the embodiment of the LED light source in FIG. 6;

FIG. 8 is a circuit block diagram according to the structure in FIG. 7;

FIG. 9 is a perspective view of an external structure of an embodiment of the light source in FIG. 6; and

FIG. 10 is a cross-section structural view of a LED light source according to yet another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

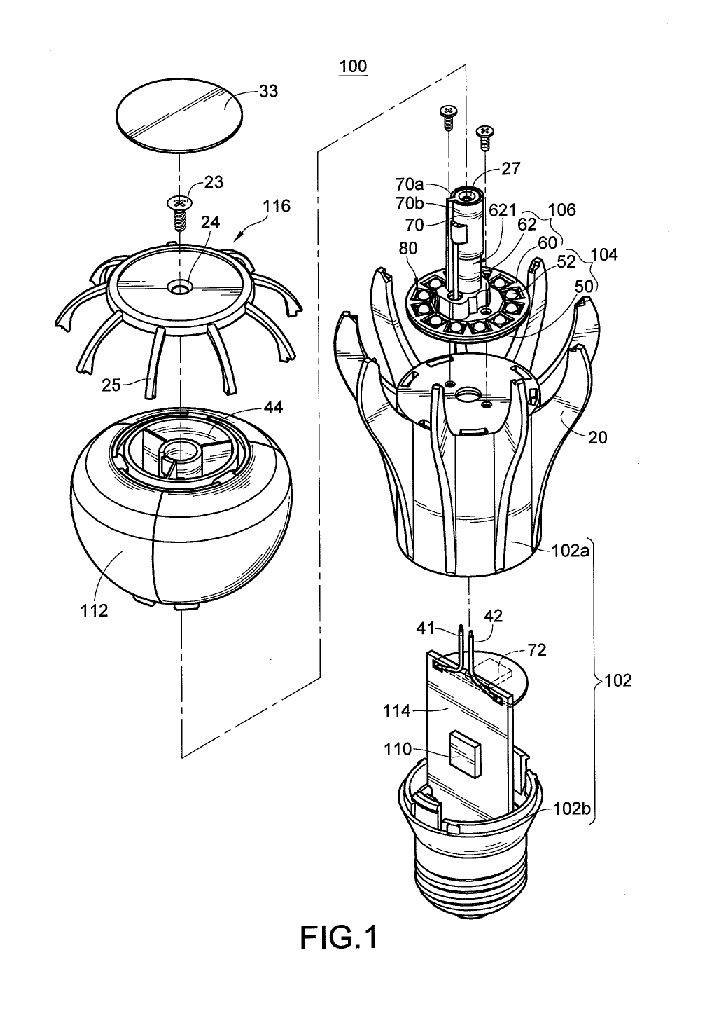

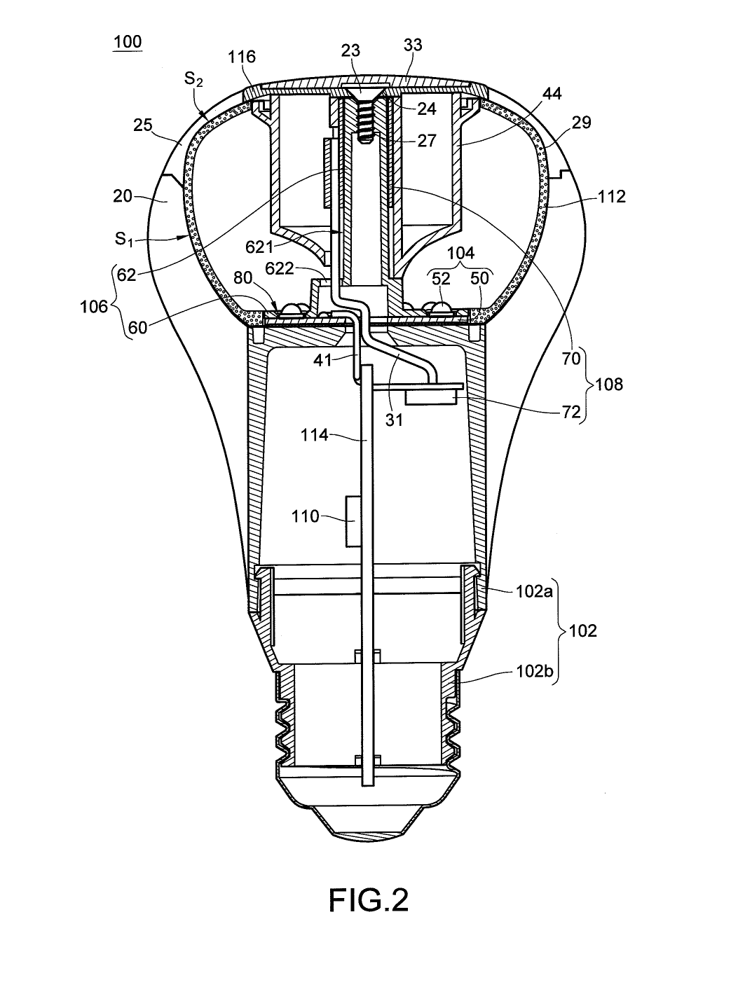

FIG. 1 shows an exploded perspective view of a LED light source according to an embodiment of the disclosure. FIG. 2 is a cross-section structural view for the LED light source in FIG. 1. In this embodiment, the light source 100 comprises a base 102, a light source plate 104, a supporting frame 106, a transceiver module 108, a driving element 110 and a secondary optical element 112. The base 102 comprises a heat dissipation block 102a and a light source interface 102b, the light source plate 104 comprises a first circuit board 50 and a plurality of light emitting elements 52, the supporting frame 106 comprises a flat plate portion 60 and a pillar portion 62, and the transceiver module 108 comprises an antenna unit 70 and a radio frequency (RF) unit 72. In this embodiment, the light source interface 102b can be connected to an external power source (not shown in FIGS. 1 and 2) supplying the light source 100 with electricity. The light source interface 102b can be, but is not limited to a spiral light source interface. For example, the light source interface 102b can also be a GU10 type light source interface.

Furthermore, the light source plate 104 may include but is not limited to twelve light emitting elements 52. Each of the light emitting elements 52 can provide white light beams. In some embodiments, the light source plate 104 can include eight light emitting elements 52, and two of them provide red light beams, four of them provide green light beams and the other two provide blue light beams. The number of the light emitting elements 52 and colors of the light beams provided by the light emitting elements 52 can be adjusted according to requirements.

The first circuit board 50 is disposed on the base 102, and each of the light emitting elements 52 is disposed on the first circuit board 50. The flat plate portion 60 has at least one opening 80 disposing on the first circuit board 50 for exposing each of the light emitting elements 52 disposed on the first circuit board 50. In this embodiment, the flat plate portion 60 can have twelve openings 80. The twelve openings 80 correspond to the twelve light emitting elements 52 one by one, but it should not be construed as a limitation to the disclosure. For example, the flat plate portion 60 may have four openings 80, and the four openings 80 correspond to the twelve light emitting elements 52 in a manner of one corresponding to three. The pillar portion 62 is connected to the flat plate portion 60, the antenna unit 70 is disposed on the pillar portion 62, the secondary optical element 112 covers the light source plate 104, and the supporting frame 106 and the antenna unit 70 connect in parallel to the base 102.

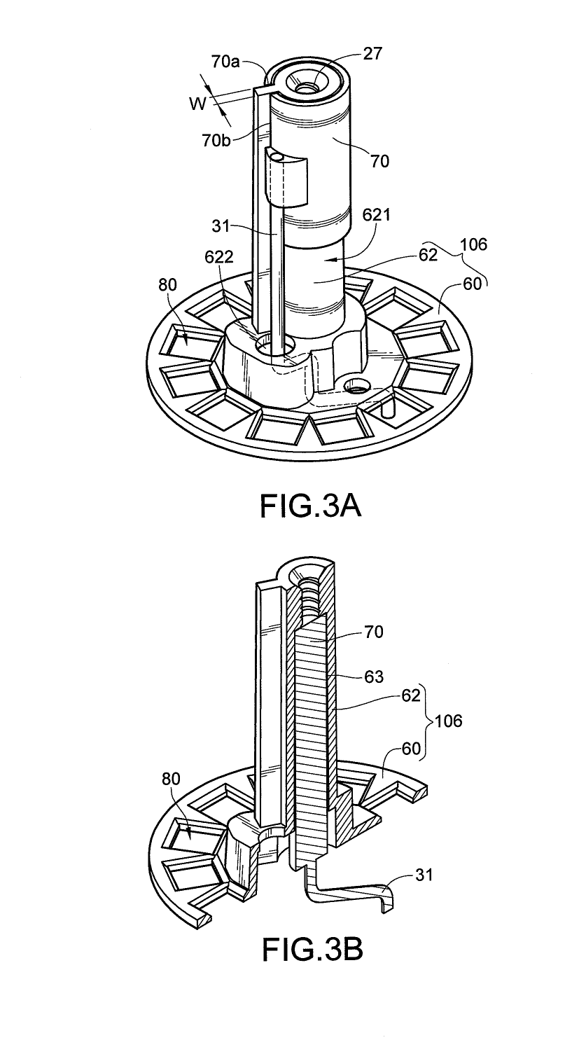

FIG. 3A is a perspective view showing the position of the antenna unit according to an embodiment of the disclosure. With reference to FIGS. 1, 2, and 3A, in this embodiment, the antenna unit 70 can be a patch antenna. The patch antenna (i.e. the antenna unit 70) surrounds a part of the surface 621 of the pillar portion 62 (a distance W between two lateral ends 70a and 70b of the patch antenna on the surface 621 is approximately 1.5 mm to 2.0 mm). A cable 31 goes through the hole 622 of the pillar portion 62 to be coupled to the patch antenna (i.e. the antenna unit 70) and the radio frequency unit 72, but this embodiment should not be construed as a limitation to the disclosure. For example, antenna unit 70 can be a pillar antenna, and the pillar portion 62 can have a space 63 for holding the pillar antenna (i.e. the antenna unit 70) in the space 63 (referring to FIG. 3B, which is a perspective view showing the position of the antenna unit according to another embodiment of the disclosure). The cable 31 can be directly coupled to the pillar antenna (i.e. the antenna unit 70) and the radio frequency unit 72 without going through the hole 622 of the pillar portion 62. It should be noted that, the antenna unit 70 needs to be disposed far away from a converter for converting an alternating current into a direct current (not shown in FIG. 3) in order to prevent from being interfered by electromagnetic waves.

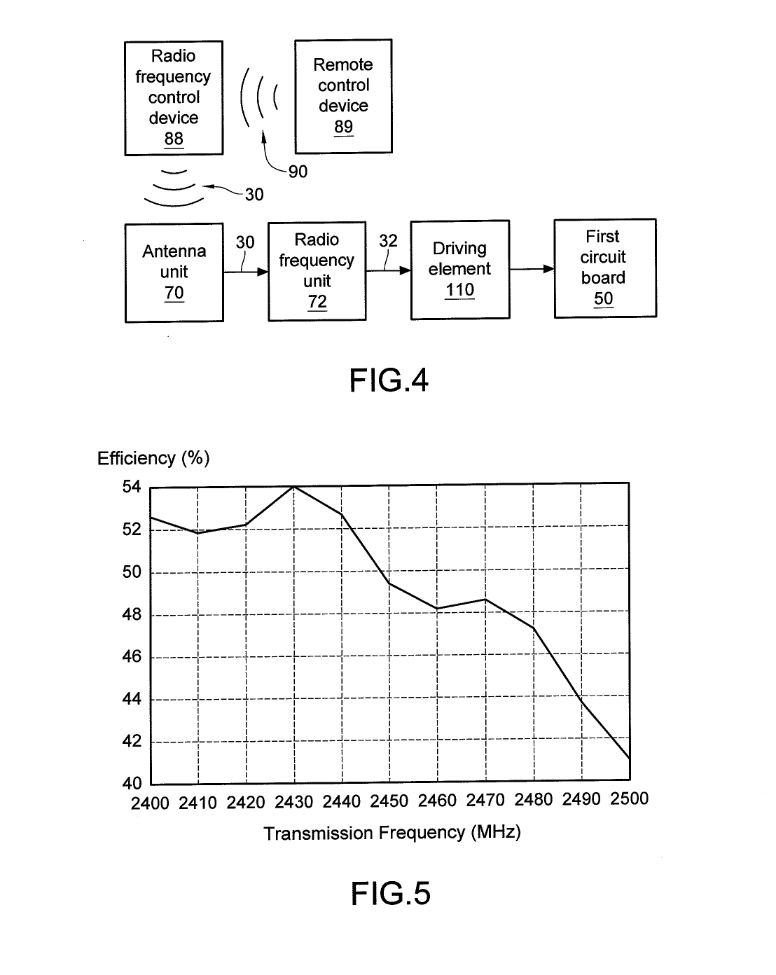

FIG. 4 is a circuit block diagram according to the structure in FIG. 2. The antenna unit 70 is coupled to the radio frequency unit 72, the radio frequency unit 72 is coupled to the driving element 110, and the driving element 110 is coupled to the first circuit board 50. The antenna unit 70 is used for receiving a radio frequency signal 30 and transmitting it to the radio frequency unit 72. The radio frequency unit 72 outputs a driving signal 32 according to the radio frequency signal 30. The driving element 110 drives each of the light emitting elements 52 according to the driving signal 32. The radio frequency signal 30 conforms to standards of ZigBee communication protocol.

In the embodiment, an infrared signal 90 sent out by a remote control device 89 is converted into the radio frequency signal 30 which conform to standards of ZigBee communication protocol by a radio frequency control device 88 or other devices to be transmitted to the antenna unit 70 to drive each of the light emitting elements 52. In other words, a user can use the remote control device 89 and the radio frequency control device 88 to remotely control the light source 100. For example, according to requirements a user may the remote control device 89 and the radio frequency control device 88 to turn on or turn off the light source 100, adjust the illumination intensity and the light field distribution of the light source 100 (i.e. turning on part of the light emitting elements 52). The remote control device 89 and the radio frequency control device 88 can be integrated into one device or configured as individual devices.

Furthermore, the radio frequency signal 30 which conforms to the standards of the ZigBee communication protocol can include group data and the driving element 110 has preset group data. If the group data preset in the driving element 110 is determined to be the same as the group data included in the radio frequency signal 30, the driving element 110 drives each of the light emitting elements 52 according to the driving signal 32. On the contrary, if the group data preset in the driving element 1101 is determined to be different from the group data included in the radio frequency signal 30, the driving element 110 does not drive each of the light emitting elements 52 according to the driving signal 32. Therefore, if the space where the user is located has a plurality of the light sources 100, since the group data preset in each of the light sources 100 can be different, the user can use the remote control device 89 and the radio frequency control device 88 to drive any one of the light sources 100, so that the illumination intensity of the space can meet users' requirements.

Referring to FIG. 2, in this embodiment, the light source 100 further comprises a second circuit board 114, power lines 41 and 42. The radio frequency unit 72 and the driving element 110 can be disposed on the second circuit board 114, but the disclosure is not limited by the embodiment. For example, the radio frequency unit 72 and the driving element 110 can also be disposed on different circuit boards. The power lines 41 and 42 are used to couple to the second circuit board 114 and the first circuit board 50 so that each of the light emitting elements 52 can be driven by the driving element 110 via the power lines 41 and 42.

Referring to FIG. 5, which is a chart showing transmission efficiencies corresponding to different transmission frequencies according to the antenna unit in FIG. 2. Because the antenna unit 70 is disposed far away from a converter (not illustrated) for converting an alternating current into a direct current in order to prevent from being interfered by electromagnetic waves, the antenna unit 70 has a transmission efficiency of approximately 54% at a transmission frequency of 2.43 gigahertz (Ghz) is.

Referring to FIGS. 1 and 2, in this embodiment, the heat dissipation block 102a can be made of a heat dissipation material with a high heat conduction coefficient. The heat dissipation block 102a may have a plurality of first heat dissipation fins 20, so that the heat generated by driving light source plate 104 can be effectively transferred to the environment where the light source 100 is disposed through the heat dissipation block 102a for heat dissipation. Furthermore, in order to further enhance the heat dissipation effect of light source 100, the first circuit board 50 can be made of, but is not limited to a metal core printed circuit board (MCPCB) with a better heat conductivity, a ceramic base or other circuit boards with better heat conduction coefficients.

The light source 100 can further comprise a heat dissipation element 116 and a locking element 23, and the heat dissipation element 116 disposed on the secondary optical element 112 has a locking hole 24 and a plurality of second heat dissipation fins 25. The locking element 23 goes through the locking hole 24 of the heat dissipation element 116 and is locked in a screw hole 27 of the pillar portion 62 so as to have the heat dissipation element 116 locked on the secondary optical element 112 and in contact with the pillar portion 62. If the locking element 23, the flat plate portion 60 and the pillar portion 62 are all made of materials with better heat conductivities, the heat generated by driving light source plate 104 can be dissipated through the flat plate portion 60, the pillar portion 62 and the second heat dissipation fms 25.

In this embodiment, the light source 100 further comprises a top cap 33 disposing on the locking hole 24 of the heat dissipation element 116 for covering the locking element 23. The top cap 33 brings beauty effect, and prevents the locking element 23 from being exposed and rusting out.

Furthermore, the light source 100 further comprises a reflecting structure 44 which is disposed around the pillar portion 62 and is connected to the heat dissipation element 116. Because the white light beams provided by each of the light emitting elements 52 have high directivity, the light source 100 can reflect a part of the white light beams by the reflecting structure 44, so that the white light beams emerged from the light source 100 can have a better optical uniformity. Furthermore, the secondary optical element 112 has a first optical surface Si and a second optical surface S2. The first optical surface Si is connected to the heat dissipation block 102a and the second optical surface S2. Particularly, the absolute slope value of a tangent of any point on the first optical surface S1 relative to the heat dissipation block 102a is substantially fixed, and the absolute slope value of a tangent of any point on the second optical surface S2 relative to the heat dissipation block 102a is gradually decreasing along the direction further away from the heat dissipation block 102. Therefore, when the white light beams provided by each of the light emitting elements 52 are transmitted to the first optical surface Si and second optical surface S2, they can be refracted effectively and then emerged outside the light source 100, so that a light field provided by the light source 100 can provide a uniform light distribution with a large angle.

Furthermore, the secondary optical element 112 can be intermingled with a plurality of diffusion particles 29, so that the white light beams can be emerged outside the light source 100 by diffusion or scattering in addition to refraction, and thus an illumination area with a larger angle (all-round lighting) can be further provided.

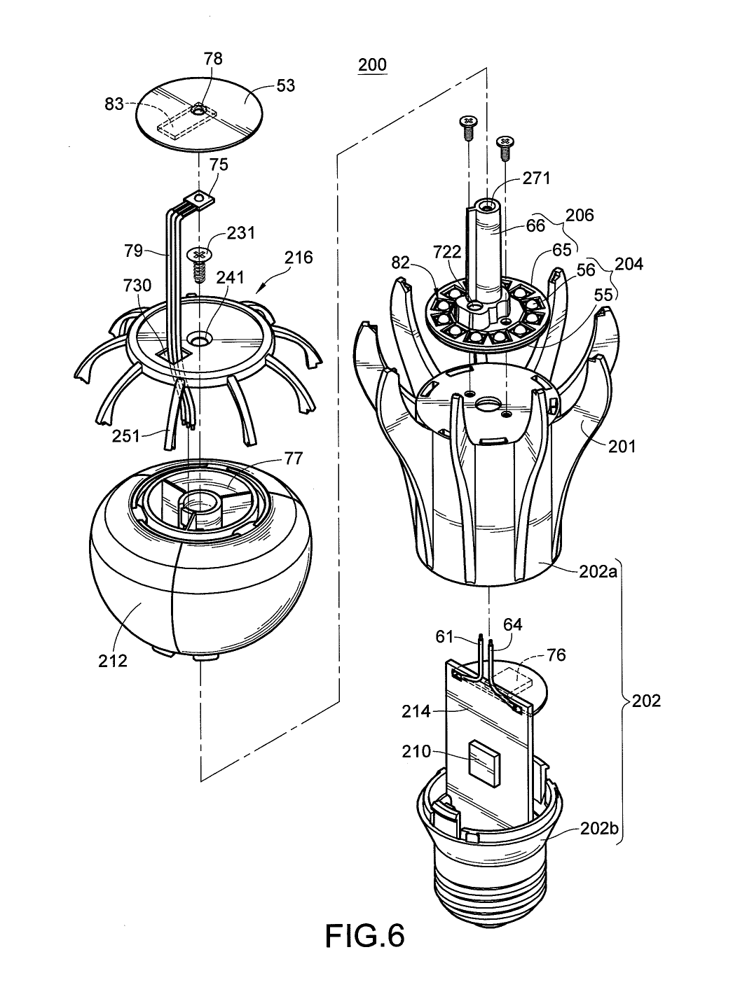

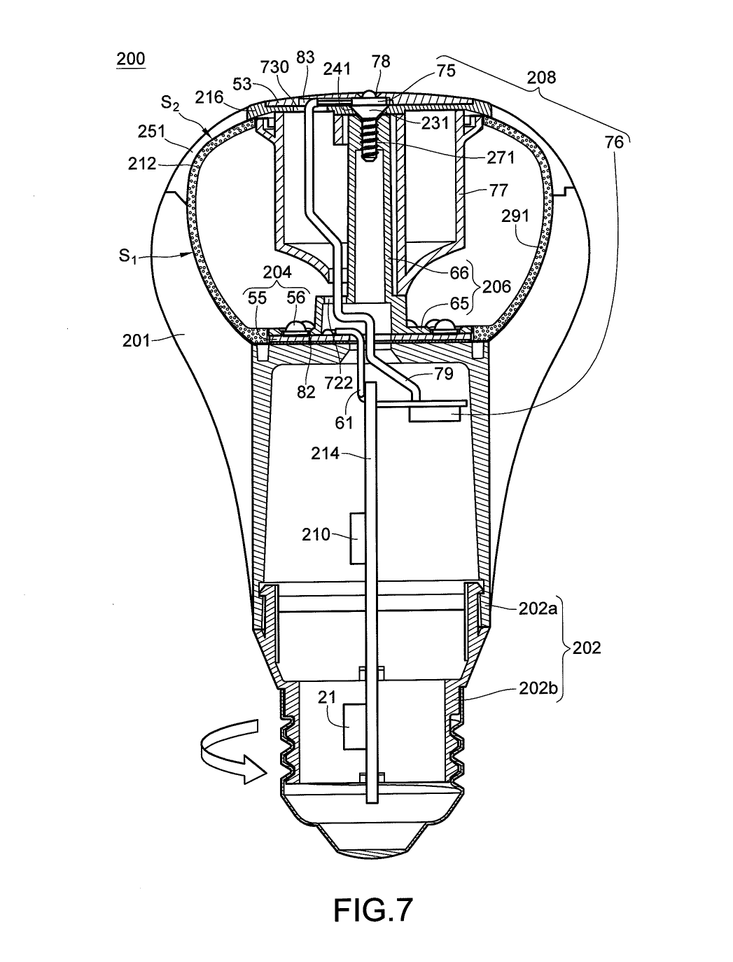

FIG. 6 is an exploded perspective view for the LED light source according to another embodiment of the disclosure. FIG. 7 is a cross-section structural view for the light source according to the embodiment shown in FIG. 6o. In this embodiment, a light source 200 comprises a base 202, a light source plate 204, a supporting frame 206, a transceiver module 208, a driving element 210 and a secondary optical element 212. The base 202 comprises a heat dissipation block 202a and a light source interface 202b. The light source plate 204 comprises a first circuit board 55 and a plurality of light emitting elements 56. The supporting frame 206 comprises a flat plate portion 65 and a pillar portion 66. The transceiver module 208 comprises a receiving unit 75 and a micro-processing unit 76. In this embodiment, the light source interface 202b can be connected to an external power source (not shown in FIGS. 6 and 7) for supplying the light source 200 with electricity. The light source interface 202b can be, but is not limited to a spiral light source interface. The light source plate 204 can include twelve light emitting elements 56, but it is not limited by the number, and each of the light emitting elements 56 can provide blue light beams. For example, the light source interface 202b can also be a GU10 type light source interface. The light source plate 204 can include four of the light emitting elements 56, and one of them provides red light beams, two of them provide green light beams, and the other one provides blue light beams. The number of the light emitting elements 56 and colors of the light beams provided by each of the light emitting elements 56 can be adjusted according to requirements.

The first circuit board 55 is disposed on the base 202, and each of the light emitting elements 56 is disposed on the first circuit board 55. The flat plate portion 65 has at least one opening 82 disposing on the first circuit board 55 for exposing each of the light emitting elements 56 disposed on the first circuit board 55. In this embodiment, the flat plate portion 65 can have twelve openings 82, and the twelve openings 82 corresponds to the twelve light emitting elements 56 one by one, but it should not be construed as a limitation to the disclosure. For example, the flat plate portion 65 can have one opening 82, and the opening 82 corresponds to the twelve light emitting elements 56 in a manner of one corresponding to twelve. The secondary optical element 212 covers the light source plate 204 and the supporting frame 206 and it is connected to the base 202. The pillar portion 66 is connected to the flat plate portion 65 and it has a hole 722.

Furthermore, the light source 200 can further comprise a heat dissipation element 216 and a locking element 231. The heat dissipation element 216 disposed on the secondary optical element 212 has a locking hole 241, a hole 730 and a plurality of second heat dissipation fins 251. The locking element 231 goes through the locking hole 241 of the heat dissipation element 216 and is locked in a screw hole 271 of the pillar portion 66 so as to have the heat dissipation element 216 locked on the secondary optical element 212 and in contact with the pillar portion 66. The receiving unit 75 can be disposed on the locking hole 241 of the heat dissipation element 216 to cover the locking element 231.

In this embodiment, the light source 200 can further comprise a top cap 53 disposing on the heat dissipation element 216. The top cap 53 has a hole 78 and a groove 83. The receiving unit 75 can be held in the groove 83 of the top cap 53 to be prevented from abrasion. The hole 78 of the top cap 53 can expose a part of the receiving unit 75 to receive an infrared signal 46.

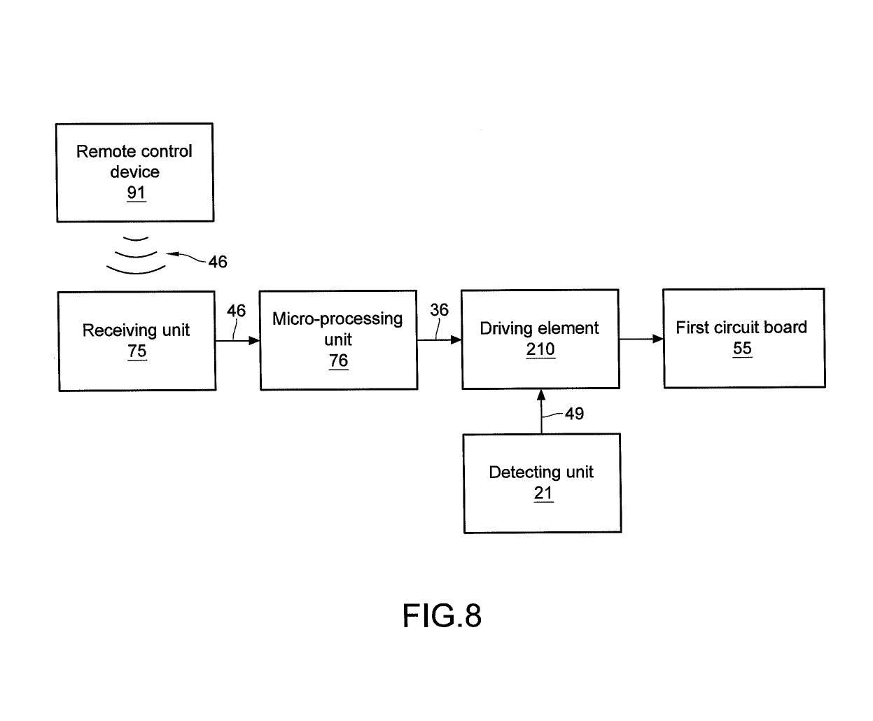

Referring to FIGS. 7 and 8, FIG. 8 is a circuit block diagram according to the structure in FIG. 7. The receiving unit 75 is coupled to the micro-processing unit 76, and the micro-processing unit 76 is coupled to the driving element 210. The driving element 210 is coupled to the first circuit board 55. The receiving unit 75 is used for receiving the infrared signal 46 and transmitting it to the micro-processing unit 76. The micro-processing unit 76 receives and decodes the infrared signal 46 to output a driving signal 36. The driving element 210 drives each of the light emitting elements 56 according to the driving signal 36. The infrared signal 46 may be an infrared signal sent out by a remote control device 91 but it is not limited thereto. In other words, a user can turn on or turn off the light source 200 and adjust illumination intensity and light field distribution of the light source 200 through the remote control device 91. The infrared signal 46 received by the receiving unit 75 can be transmitted to the micro-processing unit 76 via three transmitting wires 79 going through the hole 722 and the hole 730.

In this embodiment, the driving element 210 may comprise a detecting unit 21 which is used for detecting the relative positions of the heat dissipation block 202a and the light source interface 202b and outputting group signals 49 to the driving element 210 correspondingly. The driving element 210 uses the group signals 49 to determine whether to drive each of the light emitting elements 56 according to the driving signal 36. The driving signal 36 includes the group data used by users who intend to drive the light source 200.

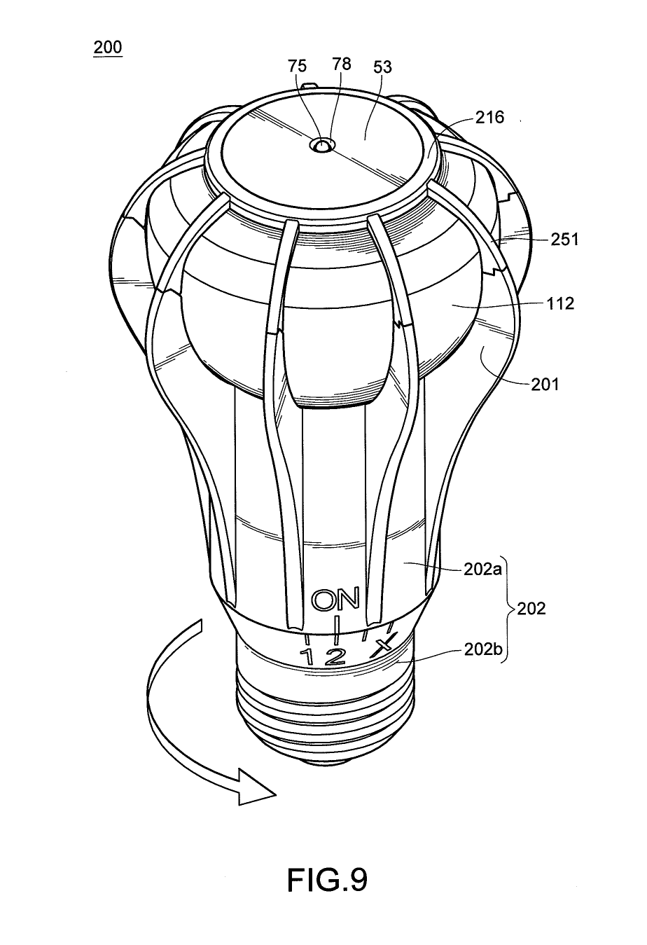

Referring to FIGS. 7 and 9, FIG. 9 is a perspective view of an external structure according to the embodiment shown by FIG. 6. In this embodiment, the detecting unit 21 is but not limited to a position sensor. The heat dissipation block 202a has a mark ON and the light source interface 202b has marks 1, 2, 3, . . . , X, wherein X can be a positive integer greater than or equal to 2. When the heat dissipation block 202a rotates in relative to the light source interface 202b to make the mark ON on the heat dissipation block 202a aligned with any one of the marks on the light source interface 202b, for example, the mark 2, the position sensor (i.e. the detecting unit 21) detects a relative rotating angle between the heat dissipation block 202a and the light source interface 202b and outputs the corresponding group signals 49 to the driving element 210. Each of the group signals 49 corresponds to a group data.

If the driving element 210 determines that the group data corresponding to the group signals 49 is the same as the group data included in the driving signal 36 which the user intends to use, the driving element 210 drives each of the light emitting elements 56 according to the driving signal 36. On the contrary, if the driving element 210 determines that the group data corresponding to the group signals 49 is different from the group data included in the driving signal 36 which the user intends to use, the driving element 210 does not drive each of the light emitting elements 56 according to the driving signal 36. Therefore, if the space where the user is located has a plurality of the light sources 200, since there are different relative positions between the heat dissipation block 202a and the light source interface 202b in each of the light sources 200, a user may use the infrared signal 46 sent out by the remote control device 91 to drive the light sources 200 with different group data, so that the illumination intensity of the space can meet users' requirements.

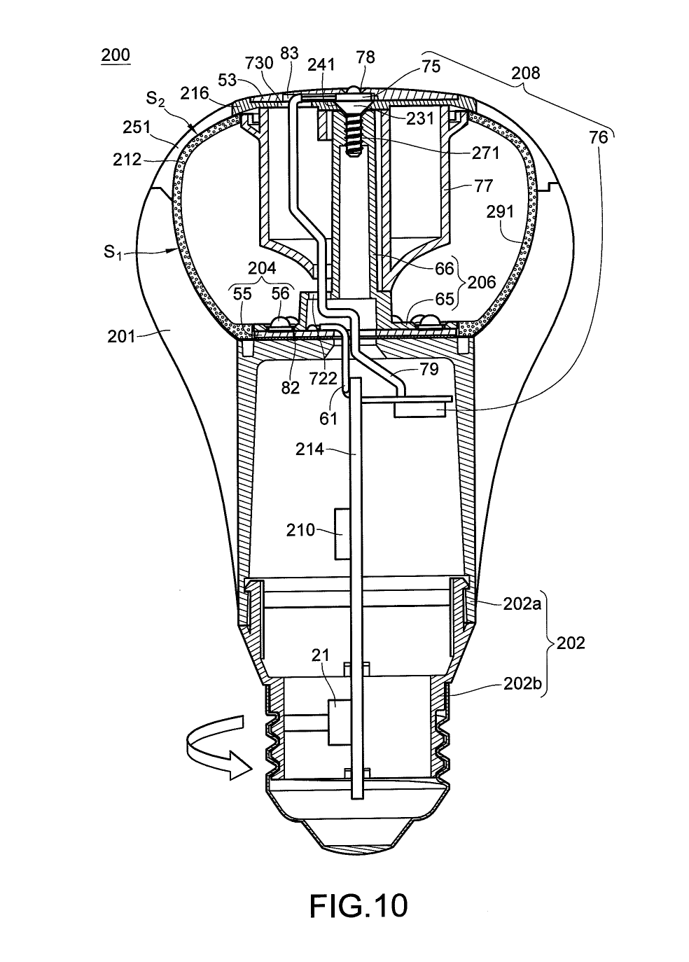

The detecting unit 21 of the above embodiment can be, but is not limited to a position sensor. For example, the detecting unit 21 can also be a multistage switch (referring to FIG. 10, which is a cross-section structural view of a LED light source according to yet another embodiment of the disclosure). When the heat dissipation block 202a rotates in relative to the light source interface 202b to make the mark ON on the heat dissipation block 202a aligned with any one of the marks on the light source interface 202b, the multistage switch (i.e. the detecting unit 21) can be switched to output the corresponding group signals 49 to the driving element 210 according to a relative position between the heat dissipation block 202a and the light source interface 202b (i.e. a relative position of the mark ON on the heat dissipation block 202a aligned with any one of the marks on the light source interface 202b). Each of the group signals 49 corresponds to a group data. The method for determining whether to drive o each of the light emitting elements 56 according to the driving signal 36 by using the group signals 49 is the same as the method when the detecting unit 21 is a multistage switch. The method will not be described herein again.

Referring to FIG. 7, in this embodiment, the light source 200 further comprises a second circuit board 214, power lines 61 and 64. The micro-processing unit 76 and the driving element 210 can be disposed on the second circuit board 214, but the disclosure is not limited by the embodiment. For example, the micro-processing unit 76 and the driving element 210 can also be disposed on different circuit boards. The power lines 61 and 64 are used to couple to the second circuit board 214 and the first circuit board 55 so that the driving element 210 can drive each of the light emitting elements 56 via the power lines 61 and 64.

In this embodiment, the heat dissipation block 202a can be made of a heat dissipation material with a high heat conduction coefficient. The heat dissipation block 202a can have a plurality of first heat dissipation fins 201, so that the heat generated by driving light source plate 204 can be effectively transferred to the environment where the light source 200 is disposed through the heat dissipation block 202a for heat dissipation. Furthermore, in order to further enhance the heat dissipation effect of the light source 200, the first circuit board 55 can be made of, but is not limited to a metal core printed circuit board (MCPCB) with a better heat conductivity, a ceramic base or other circuit boards with better heat conduction coefficients.

Furthermore, the light source 200 may further comprise a reflecting structure 77 which is disposed around the pillar portion 66 and is connected to the heat dissipation element 216. Because the blue light beams provided by each of the light emitting elements 56 have high directivity, the light source 200 can reflect a part of the blue light beams by reflecting structure 77, so that the blue light beams emerged from the light source 200 can provide a better optical uniformity. Furthermore, the secondary optical element 212 has a first optical surface S1 and a second optical surface S2, and the first optical surface S1 is connected to the heat dissipation block 202a and the second optical surface S2. Particularly, the absolute slope value of a tangent of any point on the first optical surface S1 relative to the heat dissipation block 202a is substantially fixed, and the absolute slope value of a tangent of any point on the second optical surface S2 relative to the heat dissipation block 202a is gradually decreasing along the direction further away from the heat dissipation block 202a. Therefore, when the blue light beams provided by each of the light emitting elements 56 are transmitted to the first optical surface S1 and second optical surface S2, they can be refracted effectively and then emerged outside the light source 200, so that a light field provided by the light source 200 can provide a uniform light distribution with a large angle.

Furthermore, the secondary optical element 212 can be intermingled with a plurality of diffusion particles 291, so that the blue light beams can be emerged outside the light source 200 by diffusion or scattering in addition to refraction, and thus an illumination area with a larger angle (all-round lighting) can be further provided.

According to the above, according to the embodiments of the LED light source, users can turn on or turn off, and adjust the illumination intensity and the light field distribution of the light source wirelessly and remotely through the transceiver module. The transceiver module can receive infrared or radio frequency signals.

Furthermore, if the space where the user is located has a plurality of the light sources and the signals received by the transceiver modules are radio frequency signals, since the radio frequency signals include group data, each of the driving elements can determine whether to drive the light source according to the driving signal by comparing the group data included in the radio frequency signal with the group data set in each of the driving elements.

If the space where the user is located has a plurality of light sources and the signals received by the transceiver modules are infrared signals, the detecting unit can output group signals for determining each of the light sources for defining the group according to the relative positions of the heat dissipation block and the light source interface, and each of the driving elements can determine whether to drive the light source according to the driving signal by comparing the group data included in the group signals with the group data that the user intends to use for driving the light source included in the driving signal. The detecting unit can be a multistage switch or a position sensor.

Furthermore, the antenna unit of the disclosure is disposed far away from a converter for converting an alternating current into a direct current in order to prevent from being interfered by electromagnetic waves and achieve excellent transmission efficiency and receiving frequency (a transmission efficiency of the antenna unit at a transmission frequency of 2.43 gigahertz is approximately 54%). Additionally, an all-round uniform light distribution with a large angle can be achieved by the secondary optical element and the reflecting structure in the LED light source. The heat dissipation effect of the light source can be enhanced effectively by using the first heat dissipation fins and the second heat dissipation fins.

Note that the specifications relating to the above embodiments should be construed as exemplary rather than as limitative of the present invention, with many variations and modifications being readily attainable by persons skilled in the art without departing from the spirit or scope thereof as defined by the appended claims and their legal equivalents.

What is claimed is:

1. An LED light source, comprising:
a base;
a light source plate, comprising:
a first circuit board disposed on the base; and
a plurality of light emitting elements disposed on the first circuit board;
a supporting frame, comprising:
a flat plate portion disposed on the first circuit board and having at least one opening exposing the light emitting elements; and
a pillar portion connected to the flat plate portion;
a transceiver module, comprising:
an antenna unit disposed on the pillar portion for receiving and transmitting a radio frequency signal; and
a radio frequency unit coupled to the antenna unit and outputting a driving signal according to the radio frequency signal;
a driving element coupled to the radio frequency unit and the first circuit board and driving the light emitting elements according to the driving signal; and
a secondary optical element connected to the base and covering the light source plate, the supporting frame and the antenna unit.

2. The LED light source as claimed in claim 1, wherein the pillar portion has an accommodation space, and the antenna unit is disposed in the accommodation space.

3. The LED light source as claimed in claim 1, wherein the antenna unit is disposed on a partial surface of the pillar portion.

4. The LED light source as claimed in claim 1, wherein the radio frequency signal conforms to standards of ZigBee communication protocol.

5. The LED light source as claimed in claim 1, wherein LED light source further comprises a second circuit board, and the radio frequency unit and the driving element are disposed on the second circuit board.

6. The LED light source as claimed in claim 1, wherein the base comprises a heat dissipation block and a light source plug.

7. An LED light source, comprising:
a base;
a light source plate, comprising:
a first circuit board disposed on the base; and
a plurality of light emitting elements disposed on the first circuit board;
a supporting frame, comprising:
a flat plate portion disposed on the first circuit board and having at least one opening exposing the light emitting elements; and
a pillar portion connected to the flat plate portion;
a secondary optical element connected to the base and covering the light source plate and the supporting frame;
a heat dissipation element disposed on the secondary optical element;
a transceiver module, comprising:
a receiving unit disposed on the heat dissipation element for receiving and transmitting an infrared signal; and
a micro-processing unit coupled to the receiving unit, receiving the infrared signal and decoding the infrared signal to output a driving signal; and
a driving element coupled to the micro-processing unit and the first circuit board and driving the light emitting elements according to the driving signal.

8. The LED light source as claimed in claim 7, wherein the LED light source further comprises a second circuit board, and the micro-processing unit and the driving element are disposed on the second circuit board.

9. The LED light source as claimed in claim 7, wherein the base comprises a heat dissipation block and a light source plug, the driving element comprises a detecting unit, the detecting unit detects the position of the heat dissipation block relative to the light source plug for outputting group signals to the driving element correspondingly, the driving element uses the group signals to determine whether to drive the light emitting elements according to the driving signal.

10. The LED light source as claimed in claim 9, wherein the detecting unit is a multistage switch.

11. The LED light source as claimed in claim 9, wherein the detecting unit is a position sensor.
